(19) United States
(12) Patent Application Publication
(10) Pub. No.: US 2022/0139249 A1
(43) Pub. Date: May 5, 2022

(54) Method & System of Testing Multiple Cognitive Functions

(71) Applicants: Ian Perera, Winter Park, FL (US); Paul Dituro, Columbia, SC (US); Peter Pirolli, San Francisco, CA (US)

(72) Inventors: Ian Perera, Winter Park, FL (US); Paul Dituro, Columbia, SC (US); Peter Pirolli, San Francisco, CA (US)

(21) Appl. No.: 17/404,321

(22) Filed: Aug. 17, 2021

Related U.S. Application Data
(60) Provisional application No. 63/066,758, filed on Aug. 17, 2020.

(51) Int. Cl. G09B 9/00; G06Q 10/06

(52) U.S. Cl. CPC G09B 9/003; G06Q 10/063114; G06Q 10/0639

(57) ABSTRACT

A method for evaluating team performance of a first subject and a second subject in a complex task requiring communication and cooperation. A first display is provided to the first subject and a second display is provided to the second subject. Neither subject can see the other's display. One or more targets and distractor targets are provided on the displays. A designated target is revealed to the first subject on the first display. An identical target is presented on the second display, but it is not designated and it exists in a field of potential targets and distractor targets. The first subject must verbally communicate information to the second subject identifying the designated target. Elapsed time from the designation of the target to the completion of the task is measured and used to evaluate the performance of the first and second subjects.

### CROSS-REFERENCES TO RELATED APPLICATIONS

This non-provisional patent application claims the benefit—pursuant to 37 C.F.R. section 1.53(c)—of an earlier-filed provisional application. The provisional application was filed on Aug. 17, 2020, and assigned Ser. No. 63/066,758. It listed the same inventors.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1. Field of the Invention

The invention relates to the field of systems to test cognitive functions. More specifically, the invention comprises a system and method to test multiple cognitive functions used in effective communication in novel tasks.

### 2. Description of Related Art

Team-based communicative ability and physical abilities are often measured independently in distinct tasks. Thus, failing to predict performance in situations with combined communication and marksmanship challenges. On the other hand, real-world situations often require an individual to jointly carry out a task requiring focus while simultaneously verbally communicating vital information for situational awareness to facilitate team performance. Therefore, what is needed is a system and method that provides a task which tests an individual's ability to simultaneously carry out one subtask while also verbally communicating information required for a teammate's subtask.

Military operations or other high-risk or high-stress situations often require team coordination and communication simultaneously with decision-making and physical tasks. Situations change rapidly and in unexpected ways and establishing team-wide situation awareness is paramount for the safety and success of the team. However, communicating while under fire or engaged in a physical task requires a particular ability to manage an individual's task while communicating effectively and efficiently to work towards overall team success.

To this end, what is needed is a method and prototype system that tests multiple cognitive functions used in effective communication in novel tasks to evaluate and train individuals in these types of situations.

This work thus addresses the following:
(a) The need for team communication aptitude measures under stressful or distracting situations to be used in training and selection for, or prediction of, success of individuals and/or teams, or to evaluate or select optimal team composition and role assignment
(b) The need for such measures to: evaluate and/or validate of teamwork enhancing strategies and methods, or team-related optimizations; and evaluate visualizations, figures, or patterns used in mixed verbal/non-verbal communication schemes The present invention achieves these objectives, as well as others, which are explained in the following description.

### SUMMARY

The present invention comprises a method for evaluating team performance of a first subject and a second subject in a complex task requiring communication and cooperation. A first display is provided to the first subject and a second display is provided to the second subject. Neither subject can see the other's display. One or more targets and distractor targets are provided on the displays. A designated target is revealed to the first subject on the first display. An identical target is presented on the second display, but it is not designated and it exists in a field of potential targets and distractor targets.

The first subject must verbally communicate information to the second subject identifying the designated target. The second subject is able to verbally communicate questions and to provide other information as well. Elapsed time from the designation of the target to the completion of the task is measured and used to evaluate the performance of the first and second subjects. Additional elapsed times for the completion of sub-tasks may be measured and used as well.

### BRIEF DESCRIPTION OF THE SEVERAL VIEWS OF THE DRAWINGS

FIG. 1 is an exemplary depiction of sets of targets used in the present system.

FIG. 2 is an exemplary depiction of sets of targets used in the present system.

FIG. 3 is a simplified perspective view of the present system, presenting an example scenario.

FIG. 4 is a simplified perspective view of the present system, presenting an example scenario.

FIG. 5 is a simplified perspective view of the present system, presenting an example scenario requiring number processing.

FIG. 6 is a simplified perspective view of the present system, presenting an example scenario with exemplar dialogue.

FIG. 7 is a simplified perspective view of the present system, presenting an example scenario with exemplar dialogue.

FIG. 8 is a simplified perspective view of the present system, presenting an example scenario with multiple moving targets and exemplar dialogue.

### DETAILED DESCRIPTION OF THE INVENTION

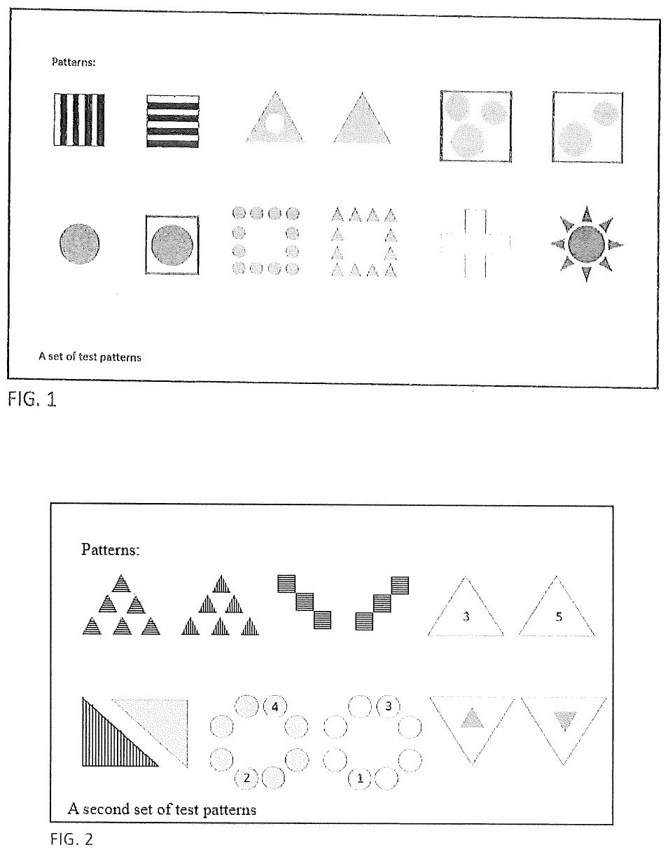

The present method and system provide a task which tests an individual's ability to simultaneously carry out one subtask while also verbally communicating information required for a teammate's subtask. Subtasks involve visually identifiable patterns, designs, objects, activities, or processes (heretofore referred to as “targets”) that are designed to be unique but occur alongside previously unseen distractor targets—requiring participants to converse to find common ground and balance specificity with succinctness, all while engaged in some individual concurrent task. These targets and subjects using the targets are shown in the attached FIGS. 1-8. Individual and team-level performance metrics are captured, including but not limited to automatic measurement of response time between target appearance, communicative acts, and subtask completion time. These performance metrics are measured and captured through the use of the targets in an online game platform, such that it allows play in browser or over game streaming applications. Although the use of an online game platform is shown and described, the present system and method can be performed in any number of known environments, such as a system that is built to provide in-person testing and targets.

Shared situation awareness is often referred to as a “shared mental model” in psychology literature, and has been shown to be predictive of team success (Cannon-Bowers et al., 1993; Cannon-Bowers & Salas, 2004; Rouse et al., 1992). The present system and method measures the generation of a shared mental model via identification of a pattern, design, object, or activity (a “target”) with distractor targets. Distractor targets may be similar to the intended target in some way and therefore confused with the intended target depending on the quality of the description. For example, FIGS. 1 and 2 include sets of patterns that can be used in the present system.

In FIG. 1, six sets of targets are shown. Each set shows two similar, but different targets—the “distractor targets.” For example, the upper left target is the actual target (a box with vertically oriented stripes). Immediately to its right is a similar distractor target (a box with horizontally oriented stripes). Every set depicted in FIG. 1 includes an actual target on the left and a similar distractor target on the right.

Similarly, in FIG. 2, six sets of additional targets are shown. Again, each set shows an actual target on the left and a distractor target on the right (The designation of actual and distractor is arbitrary. One could designate the right hand member of each set to be the actual target and the left hand member to be the distractor). The contrast of recognizable objects with distractor objects has previously been used in psychology literature with regards to overspecification (giving more information than necessary) and other communication measures, and more recently with regards to cooperation (Rubio-Fernandez, 2019). An individual's tendency to overspecify varies depending on the complexity of the environment, and can therefore be an indicator of situational awareness (Arts et al., 2011). Identification of a described target indicates that a shared mental model has been established, and the time taken to establish such a model forms one of the primary metrics of this task.

Aside from measuring shared mental model establishment, this class of tasks also supports evaluation and training of cognitive flexibility (Scott, 1962)—the ability to switch between mental tasks that require redirection of attention or utilization of different cognitive functions. Prior work on measuring cognitive measures including flexibility (such as described in U.S. Pat. No. 8,602,789; U.S. Pub. No. 2016/0213298; and U.S. Pat. No. 6,435,878) has not evaluated cognitive flexibility within a simulation of a real-world situation and cannot measure specific task-switching ability between communicative and non-communicative tasks.

Prior work on systems to evaluate teamwork focuses on following specific protocols or scripted scenarios (Virtra: U.S. Pub. No. 2006/0105299) or decision-making (U.S. Pub. No. 2014/0006336) with no automatic and quantified evaluation of novel, reactive communication. Cognitive measures utilizing a virtual environment have focused on specific individual cognitive measures with no communication evaluation (Australian Pub. No. 2018/202524). Our work is the first known effort to quantify and evaluate communication efficiency and establishment of shared mental models.

The task can be instrumented in either a virtual environment, physical space, or a combination of the two (via virtual reality (VR), augmented reality (AR), or other simulation environments (e.g., Virtra Simulators)). Two or more individuals (subjects/participants) position themselves in a separated space within the environment that allows for real-time verbal communication but partially or fully prevents visual awareness of the other participants and their environment. This separation can be enabled via a network connection between separate computers in a virtual environment, via independent VR/AR headsets, or in a physical environment separated by barriers, rooms, or separated locations. Scenarios will typically involve identification of a target and an indication of commitment to that target (“activation”) as established with an action of the individual. In a virtual environment, activation may be established by user input (e.g., mouse clicks or controller buttons) combined with video game engine or simulation logic. In a physical or semi-physical environment, activation may be established with a combination of remote triggers and sensors on targets or in the environment. These activations can also be associated with other subtasks requiring further communication.

We have developed a proof of concept in a virtual environment for a marksmanship scenario, where the targets are visual patterns serving as moving targets (in this example, “target” is used in the more specific marksmanship sense). Two participants occupy a single virtual space divided by an opaque wall which creates two target ranges out of sight of the other (Each individual can see only his or her range and cannot see the other range).

Each individual is presented with a target that is highlighted to indicate that the teammate is tasked with shooting the identical pattern target in the adjacent range. These targets, along with distractor targets (targets that are possibly similar to the intended target in some way) are presented to one or both of the participants, requiring communication to establish a shared mental model and complete the task by shooting the intended targets.

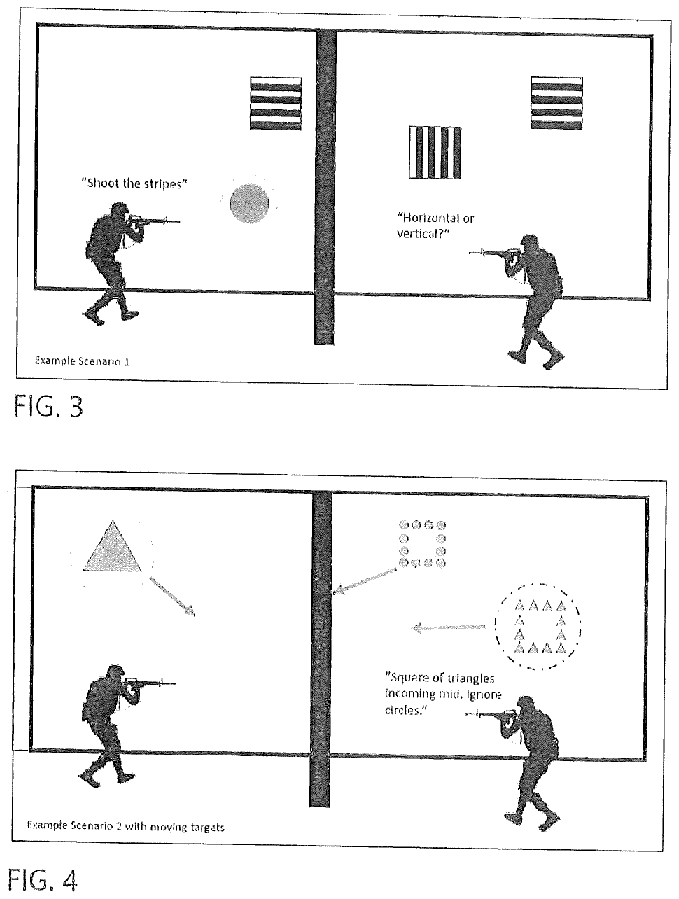

Background static targets may be provided to present an additional task to test task-switching ability in time-restricted scenarios. FIGS. 3 through 8 provide non-limiting examples of how the invention can be embodied.

Example diagrams, patterns, and images are attached. In FIG. 3, example scenario 1, two subjects are present and viewing two different screens or displays (any display means—but can be a digital display within an online game platform). The first subject is on the left and the second subject is on the right. The first subject can only see the depiction to the left of the vertical black bar and the second subject can only see the depiction to the right of the vertical black bar.

The first subject is given the information that the highlighted object (encircled in phantom lines in dahs-and-dot lines in the view) is not the target. The first subject then concludes that the target must be the box with horizontal stripes. The first subject then makes a verbal statement on the communication link: “Shoot the stripes.” The first subject makes this statement without knowing what view is presented to the second subject.

The second subject receives the command “Shoot the stripes” but the command is ambiguous since the second subject is looking at two potential targets with stripes. The second subject asks a question over the comm link: “Horizontal or vertical?” The first subject then replies: “Horizontal.” The second subject then aims and fires at the target with horizontal stripes. Detection devices are used to determine when the task objective is completed. As an example, the second subject carries a rifle with a laser emitter. When the second subject pulls the trigger, a pulse of coherent light is emitted along the rifle's bore. The target display screen also has detectors which determine whether the emitted coherent pulse has struck the target's present location. A hit is then recorded and the exercise is terminated.

Elapsed time can be recorded for the overall exercise and for subcomponents of the overall exercise. The overall exercise concludes when the target it hit. Time can be recorded for the subcomponents as well. An example is as follows:

(1) Time for first subject to issue target identifying communication;

(2) Time for second subject to response with situationally appropriate query; and

(3) Time for first subject to issue clarifying communication.

These times can be recorded and scored. Participants are trained to continue performing tasks while also communicating. Participants are also trained to communicate only the information that is needed for a given situation.

FIG. 4 depicts a scenario involving moving targets. These targets can move between the first subject's screen and the second subject's screen. It is in this manner that the subjects can communicate ahead of the other subject assessing (or seeing) the targets. Here, the second subject tells the first subject that “square of triangles is incoming middle of screen—ignore the circles”. The square of circles in this scenario is a distractor target that is programmed to appear first in the first subject's field of view. By including the statement “ignore the circles” the second subject reduces the chance of an error being made by the first subject. An even better statement might be “ignore the square of circles.”

FIG. 5 shows more examples of distractor patterns that require number processing and communication between the two subjects. The second subject is given the target designations and communicates this as “Triangle with number 3.” The first subject receives this communication and acts on it.

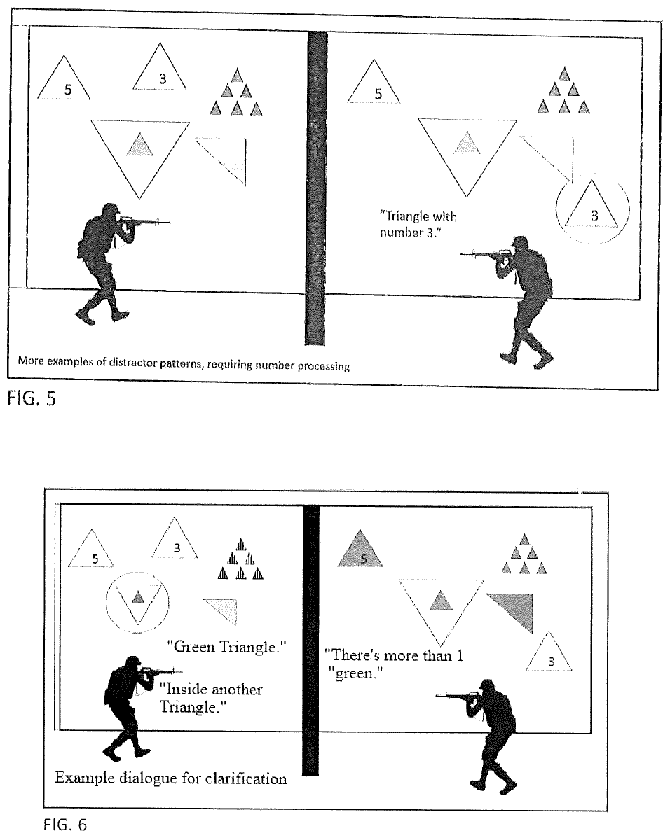

FIG. 6 shows communication where the two subjects are presented with targets having similar characteristics. In this example, the first subject instructs the second subject to shoot the “green triangle.” The second subject states that “There's more than 1 green.” Therefore, the first subject must clarify that it is “inside another triangle”. The second subject then identifies and shoots the designated target. The elapsed times are again recorded for scoring and analysis.

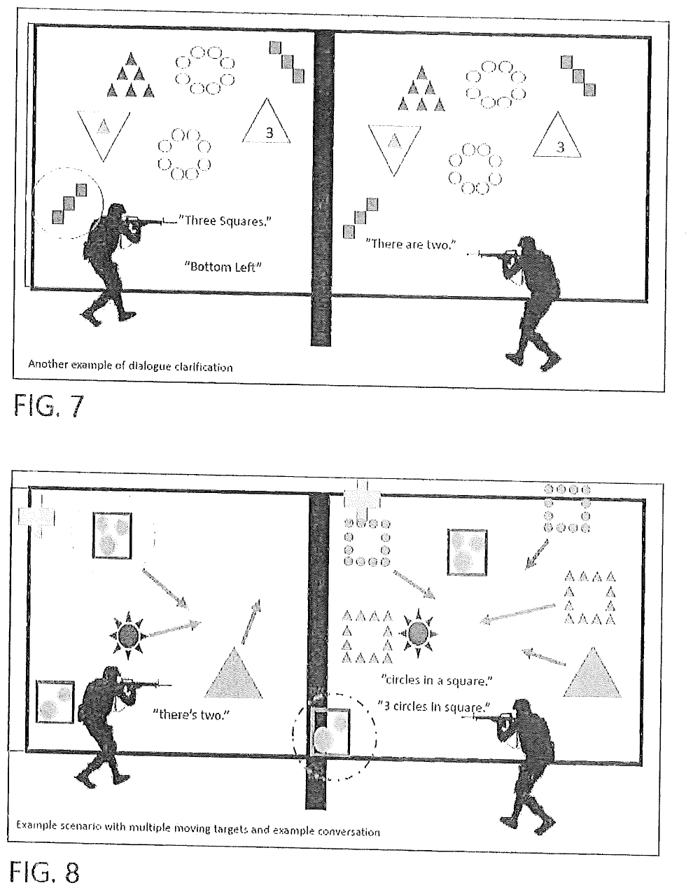

FIGS. 7 and 8 also shows two subjects with multiple targets. In FIG. 7 the targets are static and the identical display is provided to both subjects (except that the intended target is designated by a ring for the first subject but not the second subject). The first subject states “Three squares.” The second subject perceives an ambiguity and responds “There are two.” The first subject then resolves the ambiguity by stating “Bottom left.”

FIG. 8 depicts a scenario with moving objects. The second subject is given the information that the target is depicted as three circles in a square. The second subject utters the statement “circles in a square” on the comm link.” The first subject replies “there's two.” The second subject clarifies the situation by stating “3 circles in square.” The first subject then engages the correct target.

The method includes two participants, one on each side of the split target range blocking the line of sight in a timed shooting task. One participant calls out a highlighted target for teammates to shoot by describing the pattern. Distractor objects test communication specifically and require back-and-forth communication. Distractor tasks (Bianchi plates) test task-switching ability, add stress and provides a means for constructively dealing with target occlusion (waiting for the best shot). The goals of the method include evaluating reactive communication ability—speed, accuracy and specificity through pattern identification with distractors; measure deliberate versus intuitive cognition shift under stress; and evaluate effects of neural efficiency in combined shooting and communication task.

The preceding description contains significant detail regarding the novel aspects of the present invention. It should not be construed, however, as limiting the scope of the invention but rather as providing illustrations of the preferred embodiments of the invention.

Having described our invention, we claim:

1. A method for evaluating a team performance of a first subject and a second subject, comprising:
(a) providing a first display visible to said first user but not to said second user;
(b) providing a second display visible to said second user but not to said first user;
(c) displaying targets and distractor targets on said first and second displays;
(d) providing a two-way communication channel between said first and second subjects;
(e) providing a target designation to said first subject;
(f) measuring a first time between said target designation and a first communication act on said communication channel; and
(g) measuring a second time between said target designation and when said target is hit by said second subject.

2. The method for evaluating a team performance as recited in claim 1, further comprising measuring a third time between said first communication act and when said target is hit by said second subject.

3. The method for evaluating a team performance as recited in claim 1 wherein said first and second subjects are in the same location but separated by a physical barrier.

4. The method for evaluating a team performance as recited in claim 1 wherein said first and second subjects are in different physical locations.

5. The method for evaluating a team performance as recited in claim 3 wherein said communication channel is verbal communication.

6. The method for evaluating a team performance as recited in claim 1 wherein said targets and said distractor targets are moving.

7. The method for evaluating a team performance as recited in claim 1 wherein said targets and said distractor targets are a combination of numbers and shapes.

8. A method for evaluating a team performance of a first subject and a second subject, comprising:
(a) providing a first display visible to said first user but not to said second user;
(b) providing a second display visible to said second user but not to said first user;
(c) displaying targets and distractor targets on said first and second displays;
(d) providing a two-way communication channel between said first and second subjects;
(e) providing a target designation to said first subject among said targets and distractor targets presented on said first display;
(f) displaying an identical target corresponding to said designated target on said second display;
(g) wherein an identity of said displayed identical target can only be revealed by a communication act from said first subject;
(h) measuring a first time between said target designation and a first communication act on said communication channel; and
(i) measuring a second time between said target designation and when said target is hit by said second subject.

9. The method for evaluating a team performance as recited in claim 8, further comprising measuring a third time between said first communication act and when said target is hit by said second subject.

10. The method for evaluating a team performance as recited in claim 8 wherein said first and second subjects are in the same location but separated by a physical barrier.

11. The method for evaluating a team performance as recited in claim 8 wherein said first and second subjects are in different physical locations.

12. The method for evaluating a team performance as recited in claim 10 wherein said communication channel is verbal communication.

13. The method for evaluating a team performance as recited in claim 8 wherein said targets and said distractor targets are moving.

14. The method for evaluating a team performance as recited in claim 8 wherein said targets and said distractor targets are a combination of numbers and shapes.
